(19) United States
(12) Patent Application Publication
(10) Pub. No.: US 2023/0379976 A1
(43) Pub. Date: Nov. 23, 2023

(54) METHODS, APPARATUSES, AND COMPUTER READABLE MEDIA FOR SELECTING A RANDOM ACCESS PROCEDURE TYPE

(71) Applicant: Nokia Technologies Oy, Espoo (FI)

(72) Inventors: Pingping WEN, Shanghai (CN); Ping YUAN, Beijing (CN)

(21) Appl. No.: 18/248,498

(22) PCT Filed: Oct. 21, 2020
(86) PCT No.: PCT/CN2020/122451

§ 371 Date: Apr. 10, 2023

(51) Int. Cl. H04W 74/08

(52) U.S. Cl. CPC H04W 74/0833

(57) ABSTRACT

Disclosed are methods for selecting a random access procedure type. An example method may include receiving configuration information including a threshold associated with a transmission quality factor via a non-terrestrial network downlink, obtaining a value of the transmission quality factor, and selecting a 2-step random access procedure or a 4-step random access procedure based on the threshold and the obtained value of the transmission quality factor. Related apparatuses and computer readable media are also disclosed.

### TECHNICAL FIELD

Various embodiments relate to methods, apparatuses, and computer readable media for selecting a random access procedure type.

### BACKGROUND

A random access (RA) procedure between a user equipment (UE) and a base station (BS) may be a 4-step random access procedure or a 2-step random access procedure. In the 4-step random access procedure, the UE transmits to the BS a message 1 (Msg1) including a preamble on a physical random access channel (PRACH) in a first step. In a second step, the BS transmits to the UE a response as a message 2 (Msg2) including an uplink grant. In a third step, the UE transmits to the BS a message 3 (Msg3) such as a radio resource control (RRC) connection request based on the uplink grant. In a fourth step, the BS transmits message 4 (Msg4) including a cell-radio network temporary identifier (C-RNTI) of a successfully connected UE. The 2-step random access procedure is transformed from the 4-step random access procedure by combining the Msg1 and Msg3 from the UE into a single message A (MsgA) and combining the Msg2 and Msg4 from the BS into a single message B (MsgB).

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, disclosed is a method. The method may include receiving configuration information including a threshold associated with a transmission quality factor via a non-terrestrial network downlink, obtaining a value of the transmission quality factor, and selecting a 2-step random access procedure or a 4-step random access procedure based on the threshold and the obtained value of the transmission quality factor.

In some embodiments, the threshold may be further associated with a service, and the 2-step random access procedure or the 4-step random access procedure may be selected based on the service.

In some embodiments, the transmission quality factor may include a reference signal received power, and the 2-step random access procedure may be selected in a case where the obtained value of the transmission quality factor is lower than or equal to the threshold.

In some embodiments, the transmission quality factor may include a distance or a transmission latency, and the 2-step random access procedure may be selected in a case where the obtained value of the transmission quality factor is higher than or equal to the threshold.

In some embodiments, the method may further include transmitting a message for initiating the selected random access procedure.

In some embodiments, the configuration information may further include at least one of an uplink power parameter and a retransmission parameter for transmitting the message.

In a second aspect, a method is disclosed. The method may include determining configuration information including a threshold associated with a transmission quality factor, and transmitting the configuration information via a non-terrestrial network downlink. Said threshold may be used for selecting a 2-step random access procedure or a 4-step random access procedure.

In some embodiments, the threshold may be further associated with a service, and the 2-step random access procedure or the 4-step random access procedure may be selected based on the service.

In some embodiments, the transmission quality factor may include a reference signal received power to be used for selecting the 2-step random access procedure or the 4-step random access procedure.

In some embodiments, the transmission quality factor may include a distance or a transmission latency to be used for selecting the 2-step random access procedure or the 4-step random access procedure.

In some embodiments, the method may further include receiving a message for initiating the selected random access procedure.

In some embodiments, the configuration information may further include at least one of an uplink power parameter and a retransmission parameter used for the message.

In a third aspect, disclosed is an apparatus which may be configured to perform at least the method in the first aspect. The apparatus may include at least one processor and at least one memory. The at least one memory may include computer program code, and the at least one memory and the computer program code may be configured to, with the at least one processor, cause the apparatus to perform receiving configuration information including a threshold associated with a transmission quality factor via a non-terrestrial network downlink, obtaining a value of the transmission quality factor, and selecting a 2-step random access procedure or a 4-step random access procedure based on the threshold and the obtained value of the transmission quality factor.

In some embodiments, the threshold may be further associated with a service, and the 2-step random access procedure or the 4-step random access procedure may be selected based on the service.

In some embodiments, the transmission quality factor may include a reference signal received power, and the 2-step random access procedure may be selected in a case where the obtained value of the transmission quality factor is lower than or equal to the threshold.

In some embodiments, the transmission quality factor may include a distance or a transmission latency, and the 2-step random access procedure may be selected in a case where the obtained value of the transmission quality factor is higher than or equal to the threshold.

In some embodiments, the at least one memory and the computer program code may be configured to, with the at least one processor, cause the apparatus to further perform transmitting a message for initiating the selected random access procedure.

In some embodiments, the configuration information may further include at least one of an uplink power parameter and a retransmission parameter for transmitting the message.

In a fourth aspect, disclosed is an apparatus which may be configured to perform at least the method in the second aspect. The apparatus may include at least one processor and at least one memory. The at least one memory may include computer program code, and the at least one memory and the computer program code may be configured to, with the at least one processor, cause the apparatus to perform determining configuration information including a threshold associated with a transmission quality factor, and transmitting the configuration information via a non-terrestrial network downlink. Said threshold may be used for selecting a 2-step random access procedure or a 4-step random access procedure;

In some embodiments, the threshold may be further associated with a service, and the 2-step random access procedure or the 4-step random access procedure may be selected based on the service.

In some embodiments, the transmission quality factor may include a reference signal received power to be used for selecting the 2-step random access procedure or the 4-step random access procedure.

In some embodiments, the transmission quality factor may include a distance or a transmission latency to be used for selecting the 2-step random access procedure or the 4-step random access procedure.

In some embodiments, the at least one memory and the computer program code may be configured to, with the at least one processor, cause the apparatus to further perform receiving a message for initiating the selected random access procedure.

In some embodiments, the configuration information may further include at least one of an uplink power parameter and a retransmission parameter used for the message.

In a fifth aspect, disclosed is an apparatus which may be configured to perform at least the method in the first aspect. The apparatus may include means for receiving configuration information including a threshold associated with a transmission quality factor via a non-terrestrial network downlink, means for obtaining a value of the transmission quality factor, and means for selecting a 2-step random access procedure or a 4-step random access procedure based on the threshold and the obtained value of the transmission quality factor.

In some embodiments, the threshold may be further associated with a service, and the 2-step random access procedure or the 4-step random access procedure may be selected based on the service.

In some embodiments, the transmission quality factor may include a reference signal received power, and the 2-step random access procedure may be selected in a case where the obtained value of the transmission quality factor is lower than or equal to the threshold.

In some embodiments, the transmission quality factor may include a distance or a transmission latency, and the 2-step random access procedure may be selected in a case where the obtained value of the transmission quality factor is higher than or equal to the threshold.

In some embodiments, the apparatus may further include means for transmitting a message for initiating the selected random access procedure.

In some embodiments, the configuration information may further include at least one of an uplink power parameter and a retransmission parameter for transmitting the message.

In a sixth aspect, disclosed is an apparatus which may be configured to perform at least the method in the second aspect. The apparatus may include means for determining configuration information including a threshold associated with a transmission quality factor, and means for transmitting the configuration information via a non-terrestrial network downlink. Said threshold may be used for selecting a 2-step random access procedure or a 4-step random access procedure.

In some embodiments, the threshold may be further associated with a service, and the 2-step random access procedure or the 4-step random access procedure may be selected based on the service.

In some embodiments, the transmission quality factor may include a reference signal received power to be used for selecting the 2-step random access procedure or the 4-step random access procedure.

In some embodiments, the transmission quality factor may include a distance or a transmission latency to be used for selecting the 2-step random access procedure or the 4-step random access procedure.

In some embodiments, the apparatus may further include means for receiving a message for initiating the selected random access procedure.

In some embodiments, the configuration information may further include at least one of an uplink power parameter and a retransmission parameter used for the message.

In a seventh aspect, a computer readable medium is disclosed. The computer readable medium may include instructions stored thereon for causing an apparatus to perform the method in the first aspect. The instructions may cause the apparatus to perform receiving configuration information including a threshold associated with a transmission quality factor via a non-terrestrial network downlink, obtaining a value of the transmission quality factor, and selecting a 2-step random access procedure or a 4-step random access procedure based on the threshold and the obtained value of the transmission quality factor.

In some embodiments, the threshold may be further associated with a service, and the 2-step random access procedure or the 4-step random access procedure may be selected based on the service.

In some embodiments, the transmission quality factor may include a reference signal received power, and the 2-step random access procedure may be selected in a case where the obtained value of the transmission quality factor is lower than or equal to the threshold.

In some embodiments, the transmission quality factor may include a distance or a transmission latency, and the 2-step random access procedure may be selected in a case where the obtained value of the transmission quality factor is higher than or equal to the threshold.

In some embodiments, the program instructions may further cause the apparatus to perform transmitting a message for initiating the selected random access procedure.

In some embodiments, the configuration information may further include at least one of an uplink power parameter and a retransmission parameter for transmitting the message.

In an eighth aspect, a computer readable medium is disclosed. The computer readable medium may include instructions stored thereon for causing an apparatus to perform the method in the second aspect. The instructions may cause the apparatus to perform determining configuration information including a threshold associated with a transmission quality factor, and transmitting the configuration information via a non-terrestrial network downlink. Said threshold may be used for selecting a 2-step random access procedure or a 4-step random access procedure.

In some embodiments, the threshold may be further associated with a service, and the 2-step random access procedure or the 4-step random access procedure may be selected based on the service.

In some embodiments, the transmission quality factor may include a reference signal received power to be used for selecting the 2-step random access procedure or the 4-step random access procedure.

In some embodiments, the transmission quality factor may include a distance or a transmission latency to be used for selecting the 2-step random access procedure or the 4-step random access procedure.

In some embodiments, the program instructions may further cause the apparatus to perform receiving a message for initiating the selected random access procedure.

In some embodiments, the configuration information may further include at least one of an uplink power parameter and a retransmission parameter used for the message.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 shows a schematic diagram illustrating an example communication system in which embodiments of the present disclosure can be implemented.

FIG. 2 shows an exemplary signaling flow illustrating a selection of a random access procedure type according to an embodiment of the present disclosure.

FIG. 3 shows a flow chart illustrating an example method for selecting a random access procedure type according to an embodiment of the present disclosure.

FIG. 4 shows a flow chart illustrating another example method for selecting a random access procedure type according to an embodiment of the present disclosure.

FIG. 5 shows a flow chart illustrating an example method for selecting a random access procedure type according to an embodiment of the present disclosure.

FIG. 6 shows a flow chart illustrating another example method for selecting a random access procedure type according to an embodiment of the present disclosure.

FIG. 7 shows a block diagram illustrating an apparatus for selecting a random access procedure type according to an embodiment of the present disclosure.

FIG. 8 shows a block diagram illustrating an apparatus for selecting a random access procedure type according to an embodiment of the present disclosure.

FIG. 9 shows a block diagram illustrating an apparatus for selecting a random access procedure type according to an embodiment of the present disclosure.

FIG. 10 shows a block diagram illustrating an apparatus for selecting a random access procedure type according to an embodiment of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

In a communication system such as a new radio (NR) system, a round trip time (RTT) latency exists between a UE and a BS, and a differential delay exists among UEs. In a case where the communication system is a non-terrestrial network (NTN), in which the BS may include for example a satellite, the RTT latency and the differential delay may be much higher than that in a terrestrial communication system.

For example, in a case where the satellite is a regenerative geostationary earth orbit (GEO) satellite with an altitude of 35,786 km, a distance between the GEO satellite and the UE at the nadir point is 35,786 km and a one way propagation delay is 119.286 ms, and the distance between the GEO satellite and a UE for which the GEO satellite is at a 10 degree elevation angle is 40,586 km and the one way propagation delay is 135.286 ms. In this case, the differential one way delay between the UEs may reach 16 ms.

Take a regenerative low-earth orbit (LEO) satellite at 600 km altitude as another example, the maximum delay is 6,440 ms for a UE with a 10 degree elevation angle, the minimum delay is 2 ms for a UE at nadir point, and a percentage of the maximum delay is 67%.

In one or more embodiments, a 2-step RA may be selected by a UE with a high RTT latency in the NTN communication system, thus the UE may utilize one round trip cycle between transmitting MsgA and receiving MsgB in the 2-step RA, instead of two round trip cycles between transmitting Msg1 and receiving Msg4 in the 4-step RA, which leads to reduced latency and reduced signaling overhead.

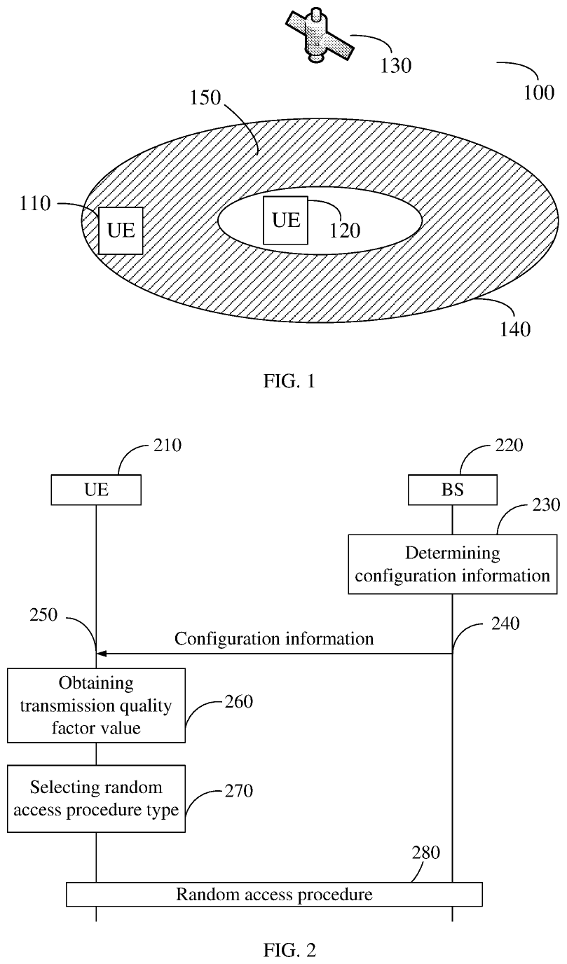

FIG. 1 illustrates an example communication network 100 in which embodiments of the present disclosure may be implemented. Referring to FIG. 1, the communication network 100 may be an NTN and include a UE 110, a UE 120 and a BS 130. Two UEs are shown as an example and it may be appreciated that the example embodiments can work for more or less UEs. The UE 110 and/or the UE 120 may be for example a NTN UE, which may be for example located at a unmanned drone or a hot air balloon. In FIG. 1, the BS 130 is illustrated as a satellite. In another example, the BS may include any suitable BS in the NTN, for example a ground based BS communicating with the UE via a satellite or an on board NTN BS implemented in a regenerative payload on board a satellite. In some embodiments, the satellite may include a LEO satellite with an altitude of 600 km, a LEO satellite with an altitude of 1500 km, a GEO satellite, etc.

A cell 140 is shown as a scope which the BS 130 may cover. UEs inside the cell 140 may connect with the BS 130 by the 2-step random access procedure or the 4-step random access procedure. The UE 110 may be an example UE which is located at a first area of the cell 140, and the UE 120 may be an example UE which is located at a second area of the cell 140. The first area may be for example the shadow area 150 shown in FIG. 1. The UE 110 in the first area may have a relatively poor reference signal received power (RSRP), or may have a longer distance or higher transmission latency relative to the UE 120 in the second area. The UE 110 may select the 2-step random access procedure. The second area may be for example an area inside the shadow area 150 shown in FIG. 1. The UE 120 in the second area may have a relatively good RSRP, or may have a shorter distance or lower transmission latency relative to the UE 110 in the first area. The UE 120 may select the 4-step random access procedure.

FIG. 2 shows an exemplary sequence chart of a selection of a random access procedure type according to an embodiment of the present disclosure. Referring to FIG. 2, a UE 210 may for example be the UE 110 or UE 120, and the BS 220 may be for example the BS 130 described with reference to the FIG. 1.

In an operation 230, the BS 220 may determine configuration information including a threshold which may be associated with a transmission quality factor. The threshold may be used to select the 2-step random access procedure and the 4-step random access procedure respectively. The transmission quality factor may include a RSRP, a distance or a transmission latency, which may be related to the transmission quality of a signal between the UE 210 and the BS 220.

The threshold may be further associated with a service. The services may correspond to respective logical channels (LCHs)/radio bearers. For the same UE, quality of service (QoS) requirements may be different for different services, and thus for different services, the transmission quality factors may be set differently. In case where the threshold is further associated with the QoS requirements of the services, the threshold may also be set to facilitate the service with a smaller delay requirement to trigger the 2-step random access procedure. For example, for the service with larger delay requirement, the RSRP threshold may be set a smaller value, or the threshold on distance and transmission latency may be set to a larger value. For the service with smaller delay requirement, the RSRP threshold may be set to a larger value, or the threshold on distance and transmission latency may be set to a smaller value.

Alternatively, the transmission quality factor may be configured differently depending on a load condition of a cell e.g. the cell 140 in FIG. 1 for the 2-step RA. In the 2-step RA, preamble and physical uplink shared channel (PUSCH) carrying payload in an MsgA are transmitted in time division multiplexing (TDM) fashion and the PUSCH resources are reserved for the PUSCH part of the MsgA. If there are sufficient PUSCH resources for the 2-step RA in a NTN, the threshold may be set to facilitate more UEs or more kinds of services to use the 2-step random access procedure. On the other hand, if there are limited PUSCH resources for the 2-step RA in the NTN, the threshold may be set to allow less UEs or less kinds of services to use the 2-step random access procedure.

In the 2-step RA, if the MsgA PUSCH cannot be decoded correctly, the 2-step RA procedure will fall back to the 4-step RA procedure. To guarantee the correct decoding of the MsgA PUSCH, the configuration information may further include at least one of an uplink power parameter and a retransmission parameter for transmitting the MsgA, which will be discussed later.

In an operation 240, the BS 220 may transmit the configuration information to the UE 210 via the NTN downlink. For example, the configuration information may be transmitted via a broadcast downlink channel (e.g., system information block) or a dedicated downlink channel (e.g., high layer signal). In another embodiment the configuration information may be transmitted via at least one downlink signaling. For example, the at least one downlink signaling may include RACH-ConfigCommon, RACH-ConfigCommonTwoStepRA or any other suitable signaling. And in an operation 250, the UE 210 may decode and receive the configuration information via the NTN downlink.

In an operation 260, the UE 210 may obtain a value of the transmission quality factor. The transmission quality factor value obtained may correspond to the type of the transmission quality factor included in the received configuration information. For example, if the RSRP threshold is included in the configuration information, the UE 210 may measure a downlink RSRP at the UE 210. Besides, if the distance threshold is included in the configuration information, the UE 210 may calculate a distance from the BS 220 and the UE 210. For example, if the transmission latency threshold is included in the configuration information, the UE 210 may calculate a transmission latency of a signal from the BS 220 to the UE 210. The transmission latency/distance may be calculated based on for example the ephemeris information of the satellite broadcast from the BS 220 and the location of the UE 210. It may be appreciated that in the terrestrial network the transmission latency/distance may also be calculated. The location of the UE 210 may be calculated through a global navigation satellite system (GNSS) such as global positioning system (GPS), global navigation satellite system (GLONASS), beidou navigation satellite system (BDS), etc., and/or by other positioning capabilities

In an operation 270, the UE 210 may select a 2-step random access procedure or a 4-step random access procedure based on the threshold and the obtained value of the transmission quality factor. For example, if the RSRP threshold is included in the configuration information, the UE 210 may compare the RSRP threshold with the measured RSRP and may select the 2-step random access procedure if the measured RSRP is lower than or equal to the RSRP threshold or select the 4-step random access procedure if the measured RSRP is higher than the RSRP threshold.

For example, if the distance threshold is included in the configuration information, the UE 210 may compare the distance threshold with the calculated distance and may select the 2-step random access procedure if the calculated distance is higher than or equal to the distance threshold or select the 4-step random access procedure if the calculated distance is lower than the distance threshold.

For example, if the transmission latency threshold is included in the configuration information, the UE 210 may compare the transmission latency threshold with the calculated transmission latency and may select the 2-step random access procedure if the calculated transmission latency is higher than or equal to the transmission latency threshold or select the 4-step random access procedure if the calculated transmission latency is lower than the transmission latency threshold.

Back to refer to FIG. 1, compared with the UE 110 in the first area, the UE 120 in the second area has a smaller distance away from the BS 130 compared with the UE 110 and has a shorter transmission latency with respect to a signal from the BS 130. And for example the RSRP measured at the UE 120 may be stronger than that at the UE 110. The received threshold may facilitate a UE such as the UE 110 instead of the UE 120 to have more opportunity to use the 2-step random access procedure to reduce the propagation delay.

Further, in a case where the threshold is also associated with the service, a UE using a service with lager delay requirement may select the 4-step RACH for the service and a UE using a service with smaller delay requirement may select the 2-step RACH for the service.

The 2-step RACH may be selected by the NTN UE to reduce the access and uplink data transmission latency considering the balance of the overall resource overhead e.g. PUSCH reservation and to fulfill service requirement in the NTN. Assuming the overall 2-step RACH resource is fixed in the NTN cell e.g. the cell 140 in FIG. 1, the uplink scheduling latency may be reduced from the perspective of the NTN cell.

The UE 210 and the BS 220 may perform a random access procedure 280 according to the selected random access procedure type.

In an embodiment, the UE 210 may further use at least one of the uplink power parameter and the retransmission parameter included in the configuration information from the BS 220 to enhance reliability of transmitting the MsgA in the 2-step RA.

The uplink power parameter may be used for uplink power control and may include for example a delta power offset (for example, Δ_{MsgA_PUSCH}), based on which the uplink transmission power of PUSCH may be increased relative to the MsgA PRACH preamble. The uplink power parameter may further include an alpha value. In this case the delta power offset and the alpha value configured for the UE using 2-step RACH may be used for increasing the transmission power to reach an improved signal to interference plus noise ratio (SINR) for MsgA PUSCH.

The retransmission parameter may also be configured for different UEs. For example, a UE which selects the 2-step RACH can be configured with large number of retransmissions, and a UE which selects the 4-step RACH can be configured with small number of retransmissions or no retransmission. The number of retransmissions may be for example 0, 1, 2, 3, 4 or any other suitable integer. The MsgA may be retransmitted by the number of retransmissions.

The uplink power parameter and/or the retransmission parameter may also be based on a service, for example depending on the LCH/radio bearer. For example, for the service with smaller delay requirement, the uplink power parameter and/or the retransmission parameter may be set to facilitate the MsgA PUSCH for the service to be correctly decoded.

The transmission power and/or the retransmission parameter can be transmitted at a different higher layer signal from the configuration information of the operation 240.

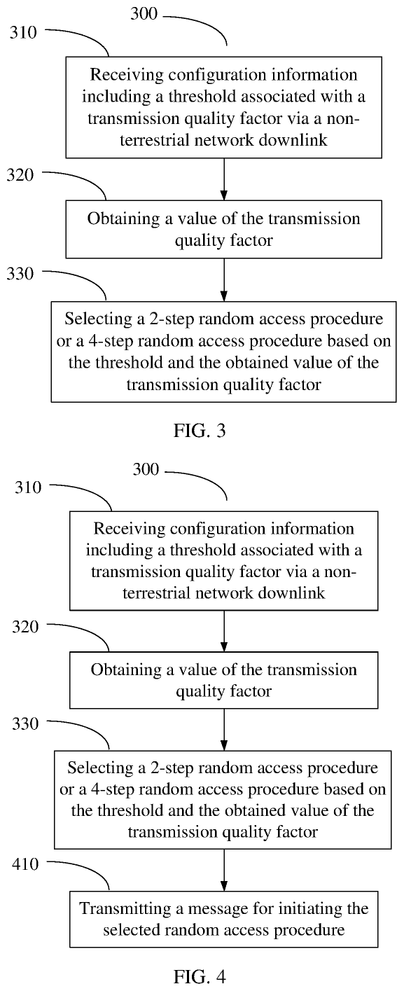

FIG. 3 shows a flow chart illustrating an example method 300 for selecting a random access procedure type according to an embodiment of the present disclosure. For a better understanding, the below description of example method 300 may be read also with reference to FIGS. 1-2. The example method 300 may be performed for example at a UE such as the UE 210.

Referring to FIG. 3, the example method 300 may include an operation 310 of receiving configuration information including a threshold associated with a transmission quality factor via a non-terrestrial network downlink, an operation 320 of obtaining a value of the transmission quality factor, and an operation 330 of selecting a 2-step random access procedure or a 4-step random access procedure based on the threshold and the obtained value of the transmission quality factor.

Details of the operations 310, 320 and 330 may refer to the above descriptions with respect to the operations 250, 260 and 270 shown in FIG. 2, respectively, and a repetitive description thereof is omitted here.

In an embodiment, the threshold may be further associated with a service, and the 2-step random access procedure or the 4-step random access procedure may be selected based on the service. The more details may refer to the above descriptions with respect to the operation 230 of FIG. 2, and a repetitive description thereof would be omitted here.

In an embodiment, the transmission quality factor may include a reference signal received power, and the 2-step random access procedure may be selected in a case where the obtained value of the transmission quality factor is lower than or equal to the threshold. In this case, the 4-step RA procedure may be selected otherwise. In another embodiment, the 4-step random access procedure may be selected in a case where the obtained value of the transmission quality factor is equal to or above the threshold, and the 2-step RA procedure may be selected otherwise.

In an embodiment, the transmission quality factor may include a distance or a transmission latency, and the 2-step random access procedure may be selected in a case where the obtained value of the transmission quality factor is higher than or equal to the threshold. In this case, the 4-step RA procedure may be selected otherwise. In another embodiment, the 4-step random access procedure may be selected in a case where the obtained value of the transmission quality factor is equal to or lower than the threshold, and the 2-step RA procedure may be selected otherwise. The more details may refer to the above descriptions with respect to the operations 230, 260 and 270 of FIG. 2, and a repetitive description thereof would be omitted here.

FIG. 4 shows a flow chart illustrating another example method for selecting a random access procedure type according to an embodiment of the present disclosure.

Referring to FIG. 4, example method 300 may include an operation 410 of transmitting a message for initiating the selected random access procedure. Details of the operation 410 may refer to the above descriptions with respect to the procedure 280 shown in FIG. 2, and a repetitive description thereof is omitted here. The operation 410 is a part of the procedure 280.

In an embodiment, the configuration information may further include at least one of an uplink power parameter and a retransmission parameter for transmitting the message. More details may refer to the above descriptions with respect to the operation 230 and the procedure 280 of FIG. 2, and a repetitive description thereof would be omitted here.

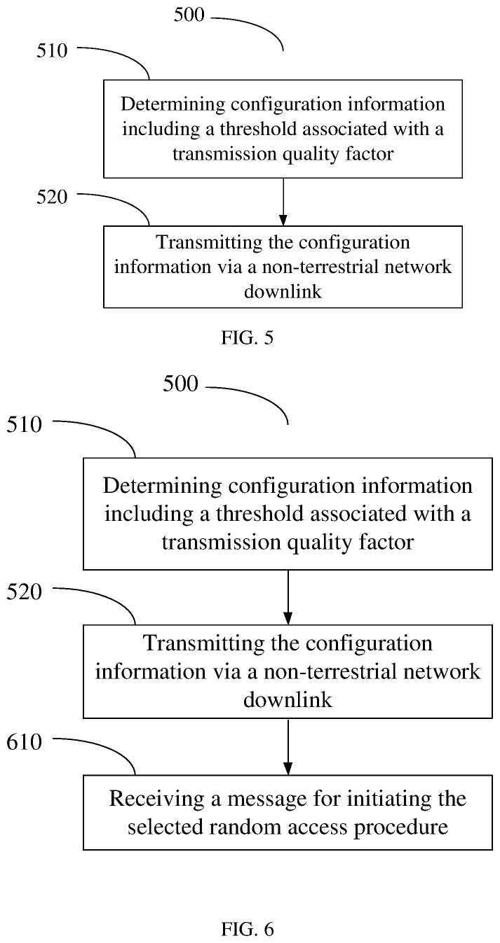

FIG. 5 shows a flow chart illustrating an example method 500 for selecting a random access procedure type according to an embodiment of the present disclosure. For a better understanding, the below description of method 500 may be read also with reference to FIGS. 1-2. The method 500 may be performed for example at a BS such as the BS 220.

Referring to FIG. 5, the example method 500 may include an operation 510 of determining configuration information including a threshold associated with a transmission quality factor, and an operation 520 of transmitting the configuration information via a non-terrestrial network downlink. Said threshold may be used for selecting a 2-step random access procedure or a 4-step random access procedure.

The example method 500 may be performed for example to cooperate with the example method 300. Thus, various features and aspects described above with respect to the example method 300 may also be applied to or included in or combined with the example method 500.

Details of the operations 510 and 520 may refer to the above descriptions with respect to the operations 230 and 240 shown in FIG. 2, respectively, and a repetitive description thereof is omitted here.

In an embodiment, the threshold may be further associated with a service, and the 2-step random access procedure or the 4-step random access procedure may be selected based on the service. More details may refer to the above descriptions with respect to the operation 230 of FIG. 2, and a repetitive description thereof would be omitted here.

In an embodiment, the transmission quality factor may include a reference signal received power to be used for selecting the 2-step random access procedure or the 4-step random access procedure. In an embodiment, the transmission quality factor may include a distance or a transmission latency to be used for selecting the 2-step random access procedure or the 4-step random access procedure. More details may refer to the above descriptions with respect to the operations 230, 260 and 270 of FIG. 2 and operations 310, 320, and 330 of FIG. 3, and a repetitive description thereof would be omitted here.

FIG. 6 shows a flow chart illustrating another example method for selecting a random access procedure type according to an embodiment of the present disclosure.

Referring to FIG. 6, example method 500 may include an operation 610 of receiving a message for initiating the selected random access procedure. Details of the operation 610 may refer to the above descriptions with respect to the procedure 280 shown in FIG. 2, and a repetitive description thereof is omitted here. The operation 610 is a part of the procedure 280.

In an embodiment, the configuration information may further include at least one of an uplink power parameter and a retransmission parameter used for the message. More details may refer to the above descriptions with respect to the operation 230 and the procedure 280 of FIG. 2, and a repetitive description thereof would be omitted here.

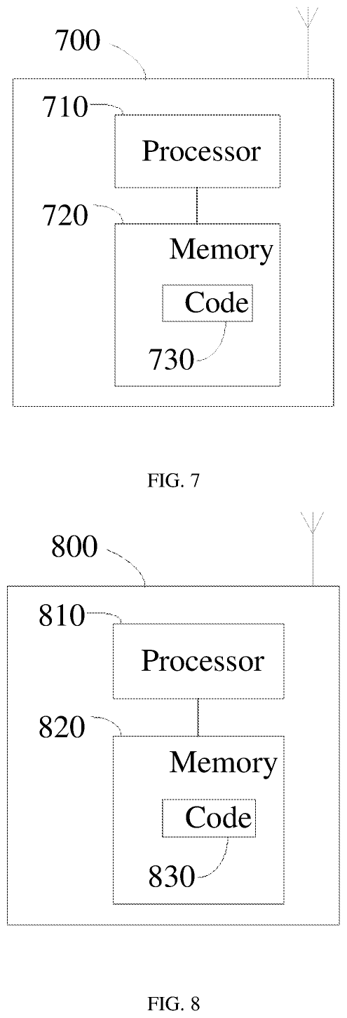

FIG. 7 shows a block diagram illustrating an apparatus for selecting a random access procedure type according to an embodiment of the present disclosure. The apparatus, for example, may be the at least part of UE 210 in the above examples.

As shown in FIG. 7, the example apparatus 700 may include at least one processor 710 and at least one memory 720 that may include computer program code 730. The at least one memory 720 and the computer program code 730 may be configured to, with the at least one processor 710, cause the apparatus 700 at least to perform the example method 300 described above and illustrated in FIG. 3 or FIG. 4.

In various example embodiments, the at least one processor 710 in the example apparatus 700 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 710 may also include at least one other circuitry or element not shown in FIG. 7.

In various example embodiments, the at least one memory 720 in the example apparatus 700 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 720 may include, but are not limited to, an electric, a magnetic, an optical, an electromagnetic, an infrared, or a semiconductor system, apparatus, or device or any combination of the above.

Further, in various example embodiments, the example apparatus 700 may also include at least one other circuitry, element, and interface, for example at least one I/O interface, at least one antenna element, and the like.

In various example embodiments, the circuitries, parts, elements, and interfaces in the example apparatus 700, including the at least one processor 710 and the at least one memory 720, may be coupled together via any suitable connections including, but not limited to, buses, crossbars, wiring and/or wireless lines, in any suitable ways, for example electrically, magnetically, optically, electromagnetically, and the like.

It is appreciated that the structure of the apparatus on the side of the UE is not limited to the above example apparatus 700.

FIG. 8 shows a block diagram illustrating an apparatus for selecting a random access procedure type according to an embodiment of the present disclosure. The apparatus, for example, may be at least part of the BS 220 in the above examples.

As shown in FIG. 8, the example apparatus 800 may include at least one processor 810 and at least one memory 820 that may include computer program code 830. The at least one memory 820 and the computer program code 830 may be configured to, with the at least one processor 810, cause the apparatus 800 at least to perform at least one of the example method 500 described above and illustrated in FIG. 5 or FIG. 6.

In various example embodiments, the at least one processor 810 in the example apparatus 800 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 810 may also include at least one other circuitry or element not shown in FIG. 8.

In various example embodiments, the at least one memory 820 in the example apparatus 800 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 820 may include, but are not limited to, an electric, a magnetic, an optical, an electromagnetic, an infrared, or a semiconductor system, apparatus, or device or any combination of the above.

Further, in various example embodiments, the example apparatus 800 may also include at least one other circuitry, element, and interface, for example at least one I/O interface, at least one antenna element, and the like.

In various example embodiments, the circuitries, parts, elements, and interfaces in the example apparatus 800, including the at least one processor 810 and the at least one memory 820, may be coupled together via any suitable connections including, but not limited to, buses, crossbars, wiring and/or wireless lines, in any suitable ways, for example electrically, magnetically, optically, electromagnetically, and the like.

It is appreciated that the structure of the apparatus on the side of the base station is not limited to the above example apparatus 800.

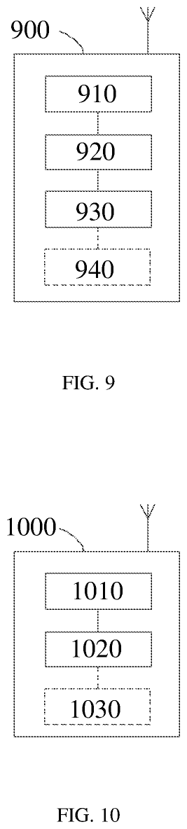

FIG. 9 shows a block diagram illustrating an apparatus for selecting a random access procedure type according to an embodiment of the present disclosure. The apparatus, for example, may be at least part of the UE 210 in the above examples.

As shown in FIG. 9, the example apparatus 900 may include means 910 for performing the operation 310 of the example method 300 illustrated in FIG. 3 or FIG. 4, means 920 for performing the operation 320 of the example method 300 illustrated in FIG. 3 or FIG. 4, and means 930 for performing the operation 330 of the example method 300 illustrated in FIG. 3 or FIG. 4. The example apparatus 900 may further include optional means 940 for performing the operation 410 of the example method 300 illustrated in FIG. 4. In one or more another example embodiments, at least one I/O interface, at least one antenna element, and the like may also be included in the example apparatus 900.

In some example embodiments, examples of means in the example apparatus 900 may include circuitries. For example, an example of means 910 may include a circuitry configured to perform the operation 310 of the example method 300 illustrated in FIG. 3 or FIG. 4, an example of means 920 may include a circuitry configured to perform the operation 320 of the example method 300 illustrated in FIG. 3 or FIG. 4, and an example of means 930 may include a circuitry configured to perform the operation 330 of the example method 300 illustrated in FIG. 3 or FIG. 4. The example apparatus 900 may further includes an example of optional means 940 including a circuitry configured to perform the operation 410 of the example method 300 illustrated in FIG. 4. In some example embodiments, examples of means may also include software modules and any other suitable function entities.

FIG. 10 shows a block diagram illustrating an apparatus for selecting a random access procedure type according to an embodiment of the present disclosure. The apparatus, for example, may be at least part of the BS 220 in the above examples.

As shown in FIG. 10, the example apparatus 1000 may include means 1010 for performing the operation 510 of the example method 500 illustrated in FIG. 5 or FIG. 6, and means 1020 for performing the operation 520 of the example method 500 illustrated in FIG. 5 or FIG. 6. The example apparatus 1000 may further includes optional means 1030 for performing the operation 610 of the example method 500 illustrated in FIG. 6. In one or more another example embodiments, at least one I/O interface, at least one antenna element, and the like may also be included in the example apparatus 1000.

In some example embodiments, examples of means in the example apparatus 1000 may include circuitries. For example, an example of means 1010 may include a circuitry configured to perform the operation 510 of the example method 500 illustrated in FIG. 5 or FIG. 6, and an example of means 1020 may include a circuitry configured to perform the operation 520 of the example method 500 illustrated in FIG. 5 or FIG. 6. The example apparatus 1000 may further include an example of optional means 1030 including a circuitry configured to perform the operation 610 of the example method 500 illustrated in FIG. 6. In some example embodiments, examples of means may also include software modules and any other suitable function entities.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While some embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and acts of the some embodiments described above can be combined to provide further embodiments. The accompanying claims and their equivalents are intended to cover such forms or modifications as would fall within the scope and spirit of the disclosure.

1.-48. (canceled)

49. A method comprising:
receiving configuration information including a threshold associated with a transmission quality factor via a non-terrestrial network downlink;
obtaining a value of the transmission quality factor; and
selecting a 2-step random access procedure or a 4-step random access procedure based on the threshold and the obtained value of the transmission quality factor.

50. The method of claim 49, wherein the threshold is further associated with a service, and the 2-step random access procedure or the 4-step random access procedure is selected based on the service.

51. The method of claim 49, wherein the transmission quality factor comprises a distance or a transmission latency, and the 2-step random access procedure is selected in a case where the obtained value of the transmission quality factor is higher than or equal to the threshold.

52. The method of claim 49, further comprising:
transmitting a message for initiating the selected random access procedure.

53. The method of claim 52, wherein the configuration information further comprises at least one of an uplink power parameter and a retransmission parameter for transmitting the message.

54. An apparatus comprising:
at least one processor; and
at least one memory comprising computer program code, the at least one memory and the computer program code being configured to, with the at least one processor, cause the apparatus to perform:
receiving configuration information including a threshold associated with a transmission quality factor via a non-terrestrial network downlink;
obtaining a value of the transmission quality factor; and
selecting a 2-step random access procedure or a 4-step random access procedure based on the threshold and the obtained value of the transmission quality factor.

55. The apparatus of claim 54, wherein the threshold is further associated with a service, and the 2-step random access procedure or the 4-step random access procedure is selected based on the service.

56. The apparatus of claim 54, wherein the transmission quality factor comprises a distance or a transmission latency, and the 2-step random access procedure is selected in a case where the obtained value of the transmission quality factor is higher than or equal to the threshold.

57. The apparatus of claim 54, wherein the at least one memory and the computer program code are further configured to, with the at least one processor, cause the apparatus to further perform:
transmitting a message for initiating the selected random access procedure.

58. The apparatus of claim 57, wherein the configuration information further comprises at least one of an uplink power parameter and a retransmission parameter for transmitting the message.

59. A computer readable medium comprising program instructions for causing an apparatus to perform:
receiving configuration information including a threshold associated with a transmission quality factor via a non-terrestrial network downlink;
obtaining a value of the transmission quality factor; and
selecting a 2-step random access procedure or a 4-step random access procedure based on the threshold and the obtained value of the transmission quality factor.

60. The computer readable medium of claim 59, wherein the threshold is further associated with a service, and the 2-step random access procedure or the 4-step random access procedure is selected based on the service.

61. The computer readable medium of claim 59, wherein the transmission quality factor comprises a distance or a transmission latency, and the 2-step random access procedure is selected in a case where the obtained value of the transmission quality factor is higher than or equal to the threshold.

62. The computer readable medium of claim 59, wherein the program instructions further cause the apparatus to perform transmitting a message for initiating the selected random access procedure.

63. The computer readable medium of claim 62, wherein the configuration information further comprises at least one of an uplink power parameter and a retransmission parameter for transmitting the message.
